(19) United States
(12) Patent Application Publication
(10) Pub. No.: US 2023/0041778 A1
(43) Pub. Date: Feb. 9, 2023

(54) METHOD AND APPARATUS FOR METERING MINIMUM LIQUID QUANTITIES

(71) Applicant: Marco Systemanalyse und Entwicklung GmbH, Dachau (DE)

(72) Inventor: Martin Reuter, Dachau (DE)

(21) Appl. No.: 17/876,994

(22) Filed: Jul. 29, 2022

(30) Foreign Application Priority Data
Aug. 9, 2021 (DE) 10 2021 120 658.8

(51) Int. Cl. B01L 3/00; G01F 13/00

(52) U.S. Cl. CPC B01L 3/50825; G01F 13/006; B01L 2300/0663; B01L 2400/0622; B01L 2400/0487; B01L 2300/041

(57) ABSTRACT

In a method for metering minimum liquid quantities, a vessel closed in a pressure-tight manner is acted on by compressed air to transport liquid from the vessel through a transfer tubing to a metering valve.

The present invention relates to a method and to an apparatus for metering minimum liquid quantities from a vessel open at one side, in particular a PCR tube.

Typical metering systems known from the prior art meter liquid media from cartridges whose media outlet is disposed at the lower end of the cartridge. Such cartridges have a typical volume of 10 ml, 30 ml, or even larger. Current designs of associated metering valves have a relatively large volume in the media channel between a cartridge connection and an outlet nozzle of the metering valve. This volume corresponds to the minimum quantity that remains at the end of the metering of a specific medium and that has to be disposed of on a subsequent cleaning of the valve. On a first filling of the metering system and the media channel after the installation of the cartridge, a relatively large quantity of medium also has to be flushed through the media channel and the nozzle outlet to ensure that the media channel is completely filled with medium and that there are no more air influences.

In the field of laboratory technology, there is furthermore the requirement to distribute a minimum quantity of a liquid medium from a vessel, for example a so-called PCR tube, to a large number of other vessels, wherein the volume of such PCR tubes typically amounts to 0.1 ml or 0.2 ml.

It is the object of the present invention to provide a method and an apparatus by which minimum liquid quantities can be efficiently metered from a vessel open at one side, i.e. can be distributed as isolated drops to other vessels.

This object is satisfied by the features of the independent claim and in particular by a method in which a transfer tubing is first introduced into the interior of the vessel up to its base. The vessel is then closed in a pressure-tight manner and acted on by compressed air so that the liquid present in the vessel is transported through the transfer tubing into a media space of a metering valve. When the liquid is present in the media space, the liquid can be metered in drop form, i.e. distributed into other containers, by opening and closing the metering valve.

In the method in accordance with the invention, minimum liquid quantities can be emptied from a vessel in a very effective manner and metered in drop form, wherein the liquid can be emptied almost completely from the vessel. By applying compressed air to the vessel, the liquid present in the vessel can be transported up to the media space of the metering valve and can subsequently be expelled from the media space by opening and closing the metering valve.

Advantageous embodiments of the invention are described in the description, in the drawing, and in the dependent claims.

In accordance with a first advantageous embodiment, the liquid can be tangentially introduced into the media space. This has proven to be particularly advantageous since liquid supplied under pressure in the media space is then moved in a circular manner or swirled in the media space, which can in particular be advantageous in a venting process in which the metering valve is briefly opened to vent the media space.

In accordance with a further advantageous embodiment, air present in the media space before the metering is first compressed and subsequently discharged from the media space by briefly opening the metering valve. By applying compressed air to the vessel, a liquid present in the vessel is first transported through the transfer tubing, and indeed until the applied pressure is no longer sufficient to further compress the air present in the media space and in the transfer tubing. If the metering valve is then briefly opened, this air can escape from the system so that the unit comprising the transfer tubing and the media space is vented.

In accordance with a further advantageous embodiment, the opening duration of the metering valve for discharging the air can be a predetermined time or can be determined by a sensor. Thus, the time duration (for example, approximately 200 ms) for which the metering valve has to be opened to allow the air present in the system to escape, but no liquid to exit, can be easily determined through tests. Alternatively or additionally, it is also possible by means of a sensor, for example an optical sensor or an ultrasonic sensor, to detect how far the liquid has progressed in the transfer tubing or in the metering valve. It is also possible, for example, by means of a light barrier or another sensor to detect an exiting of liquid from the metering valve in order to stop a venting of the system.

In accordance with a further advantageous embodiment, in the method in accordance with the invention, the leak tightness of the metering valve can be checked before the metering in that the transport of the liquid, which is acted on and transported by compressed air, through the transfer tubing and, if necessary, also through the metering valve is checked. Thus, through a few tests, it can be easily determined at which point of the transfer tubing, at a predefined pressure, the liquid present in the transfer tubing typically comes to a standstill when the metering valve is closed. However, if the liquid does not come to a standstill in this state, but continues to move in the direction of the media space, this is an indication that the metering valve does not close tightly so that it has to be serviced or replaced.

In accordance with a further advantageous embodiment, the metering duration can be a predetermined time or can be determined by a sensor. Thus, a time duration after which a predetermined liquid quantity has been completely or almost completely metered from the vessel can, in turn, be defined by empirical values. Alternatively or additionally, it can also be determined by a sensor, for example a light barrier at the outlet of the metering valve, whether a liquid drop or air exits from the metering valve when a metering stroke is performed.

In accordance with a further aspect, the present invention relates to an apparatus that is in particular suitable for performing a method of the type described above, wherein the apparatus comprises a holder for a vessel open at one side, in particular a PCR tube. A metering valve having a media space is furthermore provided, wherein a transfer tubing having a free end for insertion into the interior of the vessel is in connection with the media space. A closure having a compressed air connection is provided for the sealed closing of the vessel so that the vessel can be acted on by pressure by a compressed air source.

In such an apparatus, a metering of minimum quantities can be achieved in a very efficient manner since the vessel only has to be introduced into the holder and closed by the closure after the free end of the transfer tubing has been introduced into the interior of the vessel preferably up to its base. After an application of pressure to the vessel, a venting process can already be initiated and the metering can subsequently be started.

In accordance with an advantageous embodiment, for the sealed closing of the vessel, the closure can be fixedly connected to the holder so that the vessel is already closed in a pressure-tight manner after the insertion into the holder. This enables a cost-effective manufacture, on the one hand, and an efficient operation, on the other hand.

In accordance with a further advantageous embodiment, the holder can have a slider or a latch for fixing the vessel. The vessel can hereby be fastened in a simple manner to the holder by actuating the slider, on the one hand, and a sealed connection to the closure can hereby also be simultaneously established, on the other hand.

In accordance with a further advantageous embodiment, the transfer tubing can be arranged off-center at the closure or can be guided through the closure so that the transfer tubing does not end with its free end at the center of the vessel, but at the margin of the vessel. This has proven to be advantageous in order to empty the vessel completely, in particular if the vessel is formed as conically converging in its lower region, which is often the case with PCR tubes.

In accordance with a further advantageous embodiment, the transfer tubing can have a chamfered free end, which has an advantageous influence on a virtually residue-free emptying of the vessel.

In accordance with a further advantageous embodiment, the metering valve can have an inlet channel that is tangentially guided into the media space. An eddying of the liquid guided into the media space can hereby be achieved, which positively influences the expulsion of air on the venting of the system. The opening of the inlet channel into the media space can in this respect be arranged offset from a center axis of the media space or from an axis of symmetry of the metering valve. The inlet channel of the metering valve can also be guided at an acute angle to a center axis of the metering valve into the media space so that the liquid (when the outlet opening of the metering valve is directed downwardly) is guided obliquely from above into the media space. This also has an advantageous effect on the venting and metering process.

In accordance with a further advantageous embodiment, the compressed air connection can be in connection with a pressure regulating valve so that the interior of the vessel can be acted on by a predetermined pressure that is set by a control via the pressure regulating valve.

In accordance with a further advantageous embodiment, a sensor can be provided that detects a presence of liquid in the transfer tubing. Such a sensor can be an optical sensor that detects the liquid in a transparent or translucent transfer tubing. Other embodiments of sensors are also possible, for example, ultrasonic sensors or even bubble sensors for recognizing air pockets.

In accordance with a further advantageous embodiment, a sensor can be provided that is configured to detect the exiting of individual droplets from the metering valve. Such a sensor can, for example, be provided in the form of a light barrier that is arranged at the outlet of the metering valve.

The present invention will be described in the following purely by way of example with reference to an advantageous embodiment and to the enclosed drawings. There are shown:

FIG. 1 a perspective view of a metering apparatus before the insertion of a vessel;

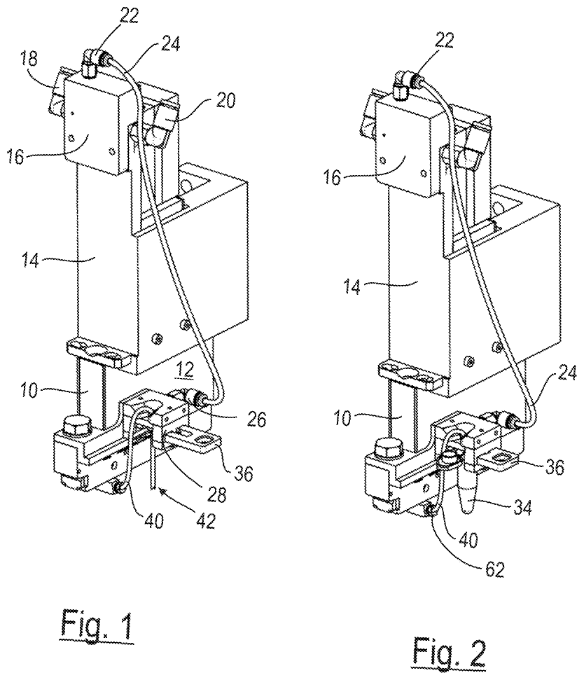

FIG. 2 the apparatus of FIG. 1 with an inserted vessel;

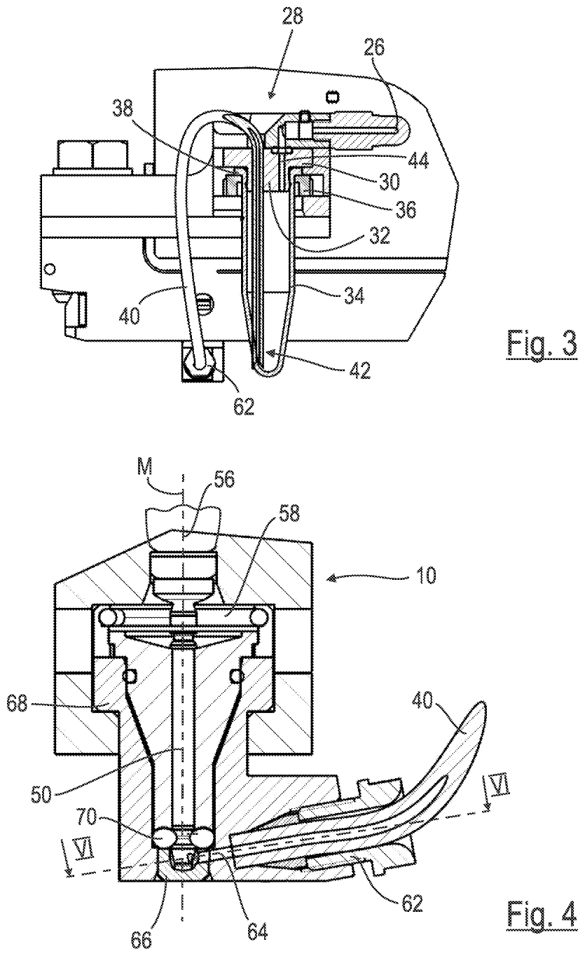

FIG. 3 a partly sectioned detailed view of the vessel holder of FIG. 1 and FIG. 2;

FIG. 4 an enlarged sectional view of the metering valve of the apparatus of FIG. 1 and FIG. 2;

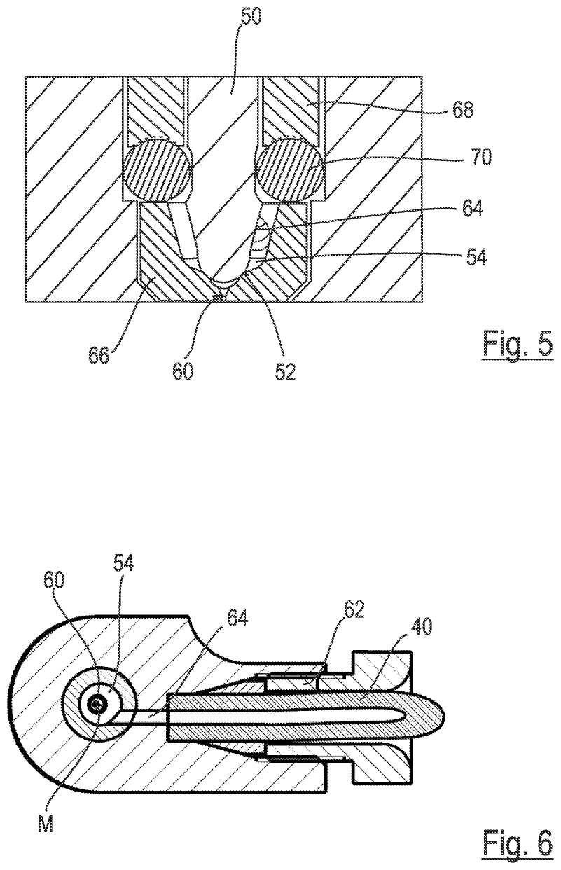

FIG. 5 an enlarged sectional representation of FIG. 4; and

FIG. 6 an enlarged sectional representation along the line VI-VI of FIG. 4.

FIG. 1 shows a metering apparatus for metering minimum liquid quantities from a vessel open at one side, in particular a PCR tube. The apparatus has a metering valve 10 having a control 12, wherein the metering valve 10 is fastened to a base 14 at which a pressure regulating valve 16 is also located. The pressure regulating valve 16 is provided with supply connections 18 and 20 and with a compressed air outlet 22 that is connected via a tubing 24 to a compressed air connection 26 of a holder 28 that is configured to receive a vessel open at one side in the embodiment shown a PCR tube.

FIG. 3 shows a partly sectioned and enlarged representation of the holder 28 of FIG. 1. The holder 28 comprises a closure 30 which is fixedly connected to the metering valve 10 and the base 14 and to which a receiver 32 is molded, with a PCR tube 34 being able to be plugged from below onto said receiver 32. In this respect, the receiver 32 of the holder 28 is configured such that the closure 30 closes the interior of the PCR tube 34 in a pressure-tight manner.

A slider 36 is provided as a fast-closure for fastening the PCR tube 34 to the holder 28 and can be pushed beneath a peripheral collar 38 of the PCR tube 34 when the latter has been plugged onto the receiver 32 of the holder 28. For this purpose, the slider 36 comprises two tines that are spaced apart from one another in parallel and that can be pushed over the lower side of the peripheral collar 38. FIG. 1 shows the apparatus with the slider 36 pulled out and FIG. 2 shows the same representation of FIG. 1 with the PCR tube 34 inserted and the slider 36 pushed in in accordance with the sectional representation of FIG. 3.

As the Figures further illustrate, a translucent and flexible transfer tubing 40 is provided for transporting liquid from the PCR tube 34 and the free end 42 of said transfer tubing 40 extends up to the base of the PCR tube 34. The free end 42 of the transfer tubing 40 is cut in a chamfered manner and contacts the inner wall of the conically converging PCR tube 34. Furthermore, the transfer tubing 40 is guided in a pressure-tight manner through the holder 28 and through the closure 30, and indeed at a point that is arranged off-center with respect to the closure 30 or the receiver 32.

To be able to apply compressed air to the interior of the PCR tube 34, the compressed air connection 26 is fastened to the closure 30 and compressed air supplied through the tubing 24 can be guided into the interior of the PCR tube 34 via the compressed air connection 26 and a compressed air passage 44 in the closure 30. As will be described in more detail in the following, by applying compressed air to the interior of the PCR tube 34, liquid present in said PCR tube 34 can be transported through the transfer tubing 40 to the metering valve 10 whose design is shown enlarged in FIG. 4 and FIG. 5.

FIG. 4 shows an enlarged sectional representation of a part of the metering valve 10 that comprises a valve needle 50 whose lower end is spherical and (cf. FIG. 5) is pressed against a valve seat 52 to tightly close a media space 54. The valve needle 50 is driven in a manner known per se by a piezo drive 56, which is not shown in greater detail, and is held in a base position by a spring 58, and is acted on by a force along a center axis M of the metering valve.

As FIG. 5 further illustrates, the metering valve 10 has an outlet channel 60 that can be closed by the metering needle 50 and that is first spherical, then conical, and finally cylindrical.

As in particular FIG. 4 illustrates, the transfer tubing 40 is connected to the metering valve 10 via a cutting screw connection 62 and the metering valve 10 has an inlet channel 64 that connects the interior of the transfer tubing 40 to the media space 54. In this respect, FIG. 6 shows that the inlet channel 64 is tangentially guided into the media space 54. Thus, a center axis of the inlet channel 64 does not intersect the center axis M of the metering valve 10, but these two axes are offset from one another. FIG. 4 also illustrates that the inlet channel 64 is guided at an acute angle to the center axis M of the metering valve 10 into the media space 54. Since the outlet channel 60 of the metering valve 10 is directed perpendicular downward in the embodiment shown, the liquid from the transfer tubing 40 is thus conducted obliquely from above into the media space 54. An O-ring 70 is provided between a valve insert 66 and a needle guide 68 to seal the media space 54.

A method for metering minimum liquid quantities from a vessel open at one side, in which the apparatus described above can be used, will be described in the following.

First, the system is completely cleaned and brought into the state shown in FIG. 1, wherein the length of the transfer tubing 40 between the holder 28 and the free end 42 of the transfer tubing 40 is selected so that the free end stands up at the base of a PCR tube 34 when the latter is fastened in the holder 28. For this purpose, the PCR tube 34 is first plugged over the free end 42 of the transfer tubing 40 and then the PCR tube 34 is plugged onto the receiver 32 of the holder 28 or of the closure 30 so that the slider 36 can be displaced from the position shown in FIG. 1 into the position shown in FIG. 2 in order to fasten or lock the PCR tube 34 to the closure 30 in a pressure-tight manner. In this respect, a minimum quantity of liquid, for example a volume of 0.1 or 0.2 ml, is present in the PCR tube 34.

Via the control provided in the metering valve 10 or via an external control, the metering valve 10 is subsequently closed and the pressure regulating valve 16 is controlled so that compressed air made available by a compressed air source (not shown) is conducted via the tubing 24 and the passage 44 into the interior of the PCR tube 34 to apply compressed air to said PCR tube 34. In this respect, a low pressure between approximately 0.5 and 2 bar can first be applied, whereby the liquid present in the PCR tube can be conveyed in the capillary-thin transfer tubing 40 up to close to the media space 54. If the liquid in this respect remains at a specific position within the transfer tubing 40, this indicates that the metering valve 10 is leak-tight between the metering needle 50 and the valve seat 52. Subsequently, the media space 54 can be filled with liquid by a temporally defined opening of the metering valve, whereby a venting simultaneously takes place. In this respect, the liquid tangentially flows into the media space 54 and finally reaches the outlet channel 60 of the metering valve 10. Since the viscosity of gas and liquid are significantly different, the liquid quantity exiting from the metering valve can be limited to a minimum, wherein the total inlet channel 64 and the media space 54 can, however, be completely filled with liquid at the same time.

After this venting process, the metering valve 10 can be operated in a desired manner, wherein drops can be metered in a desired size and frequency depending on the stroke and the frequency of the valve needle 50.

The end of the metering process can be predetermined by the control, for example, when it is known how many drops can be metered with the liquid quantity present in the PCR tube 34. However, it is also possible to detect the transport of the liquid through the transfer tubing 40 or the exiting of the liquid from the metering valve 10 by means of optical or acoustic sensors. An effective process monitoring can also take place by a sensor at the outlet of the metering valve, i.e., during the metering, it can, for example, be monitored in real time whether a metering has actually taken place and it can also be recognized when the last drop or the first drop that has no longer been metered exits the metering valve. Feedback can hereby be given to the system control when the media quantity has been completely metered.

Furthermore, it can be advantageous if the metering valve 10 and/or the transfer tubing 40 is/are provided with a bubble sensor, for example with an ultrasonic sensor, that recognizes by means of a transmission measurement whether the respective volume is filled with medium or whether air bubbles are already present. It can hereby be detected in an automated manner whether the metering medium has been consumed and air flows on through the tubing.

1. A method of metering minimum liquid quantities from a vessel open at one side, comprising the following steps:
introducing a transfer tubing into the interior of the vessel up to its base;
closing the vessel in a pressure-tight manner;
applying compressed air to the vessel and transporting the liquid from the vessel through the transfer tubing into a media space of a metering valve; and
metering the minimum quantity by opening and closing the metering valve.

2. The method in accordance with claim 1,
wherein the vessel is a PCR tube.

3. The method in accordance with claim 1,
wherein the liquid is tangentially introduced into the media space.

4. The method in accordance with claim 1,
wherein air present in the media space before the metering is first compressed and subsequently discharged from the media space by briefly opening the metering valve.

5. The method in accordance with claim 4,
wherein the opening duration of the metering valve for discharging the air is a predetermined time or is determined by a sensor.

6. The method in accordance with claim 1,
wherein the leak tightness of the metering valve is checked before the metering by observing the liquid that is acted on and transported by compressed air.

7. The method in accordance with claim 1,
wherein the metering duration is a predetermined time or is determined by a sensor.

8. An apparatus,
comprising
a holder for a vessel open at one side, in particular a PCR tube;
a metering valve having a media space;
a transfer tubing connected to the media space and having a free end for insertion into the interior of the vessel; and
a closure having a compressed air connection for the sealed closing of the vessel.

9. The apparatus in accordance with claim 8,
wherein the apparatus is configured for performing a method of metering minimum liquid quantities from a vessel open at one side, comprising the following steps:
introducing the transfer tubing into the interior of the vessel up to its base;
closing the vessel in a pressure-tight manner;
applying compressed air to the vessel and transporting the liquid from the vessel through the transfer tubing into the media space of the metering valve; and
metering the minimum quantity by opening and closing the metering valve.

10. The apparatus in accordance with claim 8,
wherein the closure is fixedly connected to the holder.

11. The apparatus in accordance with claim 8,
wherein the holder has a slider for fixing the vessel.

12. The apparatus in accordance with claim 8,
wherein the transfer tubing is arranged off-center at the closure and/or has a chamfered free end.

13. The apparatus in accordance with claim 8,
wherein the metering valve has an inlet channel that is tangentially guided into the media space.

14. The apparatus in accordance with claim 8,
wherein the metering valve has an inlet channel that is guided at an acute angle to a center axis of the metering valve into the media space.

15. The apparatus in accordance with claim 8,
wherein the compressed air connection is connected to a pressure regulating valve.

16. The apparatus in accordance with claim 8,
further comprising a sensor that detects the presence of liquid in the transfer tubing.

17. The apparatus in accordance with claim 8,
further comprising a sensor that is configured to detect the exiting of individual droplets from the metering valve.
